(19) United States
(12) Patent Application Publication
(10) Pub. No.: US 2004/0026094 A1
(43) Pub. Date: Feb. 12, 2004

(54) Support structure with fire protection

(76) Inventors: Axel Kretzschmar, Magdeburg (DE); Michael Tobias, Woerbzig (DE)

Correspondence Address: Law Offices of Karl Hormann, Post Office Box 38156, Cambridge, MA, 02238-1516, US

(21) Appl. No.: 10/312,379

(22) PCT Filed: Jun. 1, 2001
(86) PCT No.: PCT/DE01/02108

(30) Foreign Application Priority Data
Jun. 24, 2000 (DE) 100 30 971.2

(51) Int. Cl. A62C 35/00; B05B 3/00; B05B 15/10

(52) U.S. Cl. 169/16; 239/208

(57) ABSTRACT

The invention relates to a fire protection component which regardless of its functional purpose may be utilized for any structural sites of steel, metal light construction or even of wood.

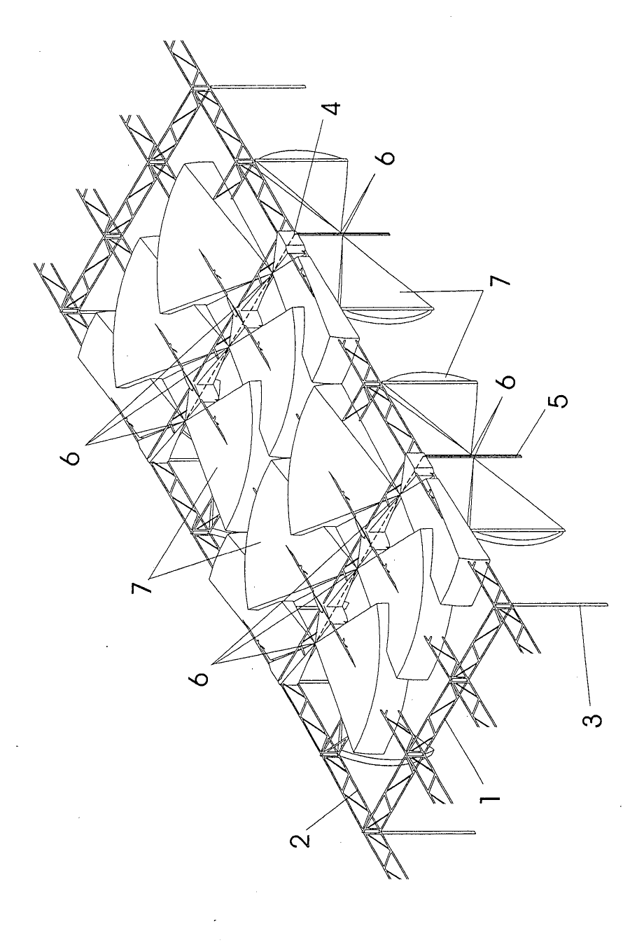

The invention is based on the problem of developing a fire resistant frame structure which at a reduced assembly and maintenance complexity provides for a long-term resistance against overheating and softening and which requires a reasonable need for extinguishing materials. The resistance against overheating is to be effective at the initial phase of a fire and in any area of the frame structure regardless of its material and consistency.

In accordance with the invention, the frame structure is laid out solely on the basis of its static requirements conditioned by its structural function quantity. Its resistance against fire is attained by the use of spray nozzles (6) as water output devices and that these are arranged along at least a part of the frame structure such that

the water exits from them as finely distributed spray droplets of aerosol, hereafter called mist,

that the marginal areas of the output cones (7) of adjacent spray nozzles (6) overlap and that in case of fire

the output cones (7) of all spray nozzles (6) activated by the fire report thus envelop the parts of the frame structure within its reach in a mist.

The invention relates to a fire resistant building frame which regardless of its purpose of functional application may be used for any structural system made of steel, light metallic construction and even wood.

Structural systems which must be fire resistant are laid out even during their planning stage and construction such that they ensure in case of fire, over their entire operational life, fire resistance for a prescribed period of time. In order to achieve this, structural systems are as a rule set up as concrete structures, or they are made from some other noncombustible material. Where steel is used as the structural material or as a skeleton, support structure or other system, special additional precautions must be taken. These are to prevent softening of the metal as a result of the effective heat generated by flames or hot combustion gases, in order to maintain the stability of the structure at least for a limited period of time and to ensure evacuation of persons present in the structural system. To impart such properties to the steel or light metal, the frames are usually coated with a thermal protection of non-combustible claddings such as concrete, fire-resistant panels or fire-impeding covers. A certain fire resistance period may also be attained by oversizing the framework.

Wooden structures are often protected by impregnation. In case of a fire, additionally installed fire extinguishers are intended to confine such fire until the arrival of a fire brigade.

Coatings of fire-resistant material as well as oversizing of the components result in very high costs and, moreover, are only effective to a limited extent. For that reason attempts have been made to form building frames and their structural components as sealed hollow profiles filled with an extinguishing agent. One of the first attempts in this respect may be found in (east) German patent 143,035. Its primary purpose is not, however, to increase the fire resistance of the frame, but, rather, a reduction of the manufacturing, assembly and material complexities of a building provided with a stationary fire extinguishing system. The cooling effect exerted by the extinguishing agent for increasing the stability of the building structure is mentioned as an additional positive effect. This favorable side effect is not, however, sufficient to reduce the material and assembly complexity of the frame structure. Rather, the building frame itself must be designed such that it possesses the requisite fire resistance. This relates to the static as well as to its cladding with fire-resistant materials. In that invention, the emphasis is placed on the reduction of the complexity of an efficient fire extinguishing system, by parts of the frame additionally assuming functions of a conventional fire extinguishing system. These parts are intended, by their hollow and water-impervious structure, to conduct the extinguishing agent in case of a fire. They also are provided with an output device for the extinguishing agent. Such an arrangement is unsuitable for protecting wooden structures.

The subject of reducing the complexity of ensuring particularly effective fire protection for building frames has been described in German utility model 93 01 963.7. In that approach, too, the frame elements are formed as thick wooden profiles and are at least partially filled with water, as is well known. In addition, steam outlet valves are provided at particularly exposed positions of the frame structure. In case of fire, the water provided within the cavity of the frame elements is heated such that it vaporizes, and the steam is ejected from the valves. This initially ensures that the temperature of the frame elements does not exceed 100° C. as long as the vaporizing water is replenished by fresh water. As an advantageous side effect the ejected steam cools the components immersed in it. It is thus understandable that in the context of this invention it is further proposed to provide steam outlet valves at especially endangered positions of the support structure, such as, for example, at the top flange in the roof section, so that the steam may protect an endangered roof from over-heating. For this purpose, the steam outlet valves are provided with steam nozzles which, in addition, may be arranged to pivot.

However, this arrangement suffers from significant draw-backs. In general, the function expected in respect of protecting those components through which no water is flowing can only be satisfied if the frame structure is completely immersed in steam. This is preconditioned on the entire frame structure being subjected to an elevated temperature. It probably requires a total conflagration or large heating or heat exchange surfaces, which usually form no part of conventional frame structures, in order effectively to utilize the generation of steam for purposes of cooling the atmosphere. From this, it may be assumed that in their initial phase fires cannot be effectively countered, even if they have been detected or if additional extinguishing devices are required to eliminate fires in their initial state.

Seen from the point of fire extinction, the contribution of steam, relative to cold water, for cooling the atmosphere is insignificant. Even the improved extinction property of steam known from specialized literature is not being utilized in this connection as the manner of arrangement of the steam nozzles is provided, and suitable, only for rinsing the components. After all, a frame structure of the kind which offers complete flow-through is statically and technologically disadvantageous and, hence, extremely expensive. This arrangement, too, is unsuitable for wooden structures.

It is also possible to reduce the effect of heat from fire and smoke gas on individual objects or components to be protected by direct spraying with an extinguishing agent. Thus, a fire-protection folding door arrangement is known from German laid open patent application 32 34 968 A1 in which the frame and support profile each consist of enclosed hollow profiles which are interconnected and, in case of fire, water will flow through them. The upper component of the door profile is provided with nozzles such that the outer surfaces of the door may be sprayed. In case of fire, the bilateral water curtain protects the door from over-heating.

A similar technical solution has been described in German laid-open patent specification No. 31 06 110 A1. Here, too, a sprinkler system is being used to improve the fire resistance of doors and the like in buildings. In case of fire, nozzles aimed at both sides of the door will cover both sides of the door leaf with a liquid film, the side of the door facing the fire being sprayed with extinguishing fluid first.

These solutions are unsuitable for complete frame structures, since very large quantities of extinguishing agent are necessary to render them effective. Moreover, they require a great many output devices for the extinguishing agent.

Hence, it is an object of the invention to develop a fire-resistant frame structure which at a reduced assembly and maintenance complexity provides for a high and long-lasting resistance against over-heating and softening and for a reasonable consumption of extinguishing agent. In this connection, the resistance against over-heating is to be effective already in the initial phase of a fire and at any area of the frame structure regardless of its material and its consistency.

In accordance with the invention, the object is accomplished by the characteristics of the first patent claim. The following claims 2 through 5 relate to functional arrangements of the nozzles as well as embodiments of the frame structure.

By the arrangement in accordance with the invention of the frame structure with nozzles which, provided with water, will in case of fire generate a water mist, the parts of the frame structure to be protected will be enveloped by water mist. In this manner, the elements of the frame structure which are provided with nozzles, i.e. the parts spraying the water mist, as well as those parts of the frame stricture which while not provided with nozzles are nevertheless enveloped by water mist, are protected from flames and heat radiation. For that reason it is possible, when both sides of the frame structure are equipped with nozzles which then spray in opposite directions, to provide only ever other or every third element of the frame structure with nozzles. Of course, the spacing between the elements of the frame structure and the width of the spay of the nozzles must be taken into consideration. In respect of the selection of nozzles and their positioning on the frame structure it is decisive that at least in their marginal areas the spray cones touch each other. Of course, it is safer if they overlap each other, so that in case of fire, all endangered areas are surrounded and irrigated by water mist. In the extreme case the entire frame structure may be provided with such protection, with the nozzles installed along the entire frame structure completely enveloping it with water mist. Advantageously, the nozzles are mounted on the lower sides of the respective frame structure elements. Advantageously, in this invention the frame structure elements provided with nozzles may be structured hollow and may thus simultaneously function as feed conduits for the nozzles.

The special advantage of the invention resides in the fact that complexity and costs of erecting structural systems are markedly lower than they would conventionally be, even ensuring an adequate fire resistance period of their frame structure in accordance with legal requirements. Thus, there is no need for fire protection claddings, and the frame structures may dimensioned solely on the basis of their static function, i.e. much smaller. This is accomplished by the inventive principle of the always possible complete enveloping in a water mist of areas of the frame structure which are endangered in case of fire. By the arrangement and equipment of the frame structure in the manner of the invention, it has from the beginning a latent fire resistance which, however, becomes effective only after detection of a fire and subsequent actuation of the nozzles. Accordingly, the required fire resistance of the structural arrangement is only provided when it is actually required, i.e. in case of fire. The realization of the inventive means proposed for this purpose is essentially known: Dimensioning the frame structure solely on the basis of static considerations and considerations relating to the structural arrangement as well as equipping the elements of the frame structure with nozzles which do not eject water as extinguishing water but spray it as a mist. The mist creates a cool fire-impeding atmosphere which prevents hot gases and vapors to move close to the elements of the frame structure, which otherwise would impermissibly raise its temperature, and thus maintaining its stability. It will thus be seen that the invention, for ensuring an adequate fire resistance period, far exceeds the current goal of ensuring a minimum fire resistance to be guaranteed for a predetermined minimum time period. The frame structure will endure the fire as long as it is enveloped by the cooling water mist. For this purpose, neither the frame structure itself nor its braces need conduct water. Of course, it is also possible to structure supports and frame structure elements as hollow profiles for suctioning off air for evaluation by a fire reporting apparatus. It is also possible to use the same hollow profiles, after detection of a fire, as water conduits to feed water to the mist nozzles. As an additional advantage of the invention, the advantageous properties of the water mist come to the fore as it slowly sinks to ground, binding smoke, heat and contaminants. This facilitates the escape of persons from the danger zone as well as the deployment of rescue personnel. Extinction of the fire is not expressly expected, but may nevertheless occur, depending upon the intensity of the fire. Rather, it is decisive that because of the presence of water mist, the atmosphere in the structural arrangement does not become enriched with heat and hot gases which may render it combustible or explosive. Last but not least, by deploying, in case of fire, mist, and refraining from pure extinction of the fire or from directly spraying parts of the frame structure, any damage from extinction agent is kept to a minimum.

The invention may be universally applied. Thus, existing older buildings in which, because of the time they were built, wood was primarily used, may be better protected from fire. Hence, the invention is of significance for protecting historically preserved buildings. However, by means of the invention it is not only possible effectively to protect of wooden structures against fire and overheating in the area of historic preservation, but also in new buildings in which wood has been used for static as well as for architectural and esthetic reasons.

The invention will hereafter be described in greater detail with reference to an example. The appurtenant drawing depicts:

a section of a framework construction of steel on supports with an arrangement installed in accordance with the invention for achieving fire resistance in a state of operation.

As may be seen in the drawing the framework structure consists of cross braces 1 and longitudinal beams 2. At each junction of the cross braces with one of the outer longitudinal beams 2 the framework structure is supported by support posts 3. Feed conduits 4 are mounted at the lower side of every third cross brace 1 and are connected to vertical feed conduits 5 extending along the support posts 3. The feed conduits 4 have been shown in dashed lines as they are usually covered by water mist and in this manner are distinct from the cross braces 1. Spray nozzles 6 are disposed on the feed conduits 4. It is useful to use water mist and/or fine water mist nozzles with a slotted output section which eject the water at a large width and extent formed as a veil consisting of droplets which range from very fine to mist. They are distributed and spaced such that the marginal areas of their output cones 7 touch each other and that the entire width of the spaces between the cross braces 1 and longitudinal beams 2 limited by the upper and lower sides thereof are filled by water mist. For purposes of clarity, the output cones 7 have been depicted as bodies delimited by exact surfaces. The intent of the invention, i.e. in case of a fire to envelop the entire frame structure in a cool and humid atmosphere, is thus rendered more recognizable. In practice, however, those areas which in the drawing are not filled by the output cones 7 are also filled by the described atmosphere. The drawing which represents the brief moment following the actuation of the arrangement, also does not show that during their slow downward movement the fine water droplets not only cool and humidify the entire space enclosed by the frame structure or the components thereof but also the support posts 3. Nevertheless, it is efficacious additionally to protect the support posts 3 directly by positioning spray nozzles 6 at the vertical conduits 5, as regarding the stability of the framework construction they are of the same importance as the cross braces 1 and longitudinal beams 2.

The spray nozzles 6 used in the present example have a reach which exceeds the distance between adjacent cross braces 1. The feed conduits 4 and vertical conduits 5 are provided with spray nozzles 6 spraying bilaterally, i.e. in opposite directions, so that adjacent cross braces 1 and adjacent support beams 3 are covered by output cones 7, and for that reason only every third cross brace 1 is provided with a feed conduit 4 and its appurtenant support beam is provided with a vertical conduit 5. In this manner the installation complexity is reduced.

Of course, as is known from the state of the art, the support beams 3 and the lower side of the cross braces 1 may be structured hollow for feeding water. The spray nozzles 6 are inserted directly into the water-conducting hollow profiles. This special lay-out in accordance with the invention serves further to reduce the complexity to ensure a fire-proof frame structure in terms of reducing installation material and complexity. The protection function against the effect of heat known from the state of the art, in this instance is of subordinate importance. Moreover making use of this effect would require the entire frame structure and all support beams 3 to be structured as hollow profiles.

The effect of the invention may on the basis of this example be explained as follows: since the water-conducting parts are permanently pressurized the spray jets 6 are closed by known glass vessel sensors. As a consequence of a fire heated air, smoke and smoke gases are rising upwardly. Upon reaching a critical temperature the glass vessel sensors will burst, and the pressurized feed conduits 4 and vertical conduits 5 disperse water through the spray jets 6. The fine water droplets described above will in the activated area fill the space between upper and lower side of the frame structure and around the support posts 3. Because of the fineness of the water droplets the combustion gasses will be cooled to below a temperature critical for the softening of steel. Depending upon the availability of the fed water it is possible to achieve an unlimited period of fire resistance.

1. A fire resistant frame structure provided with water output devices and feed conduits connecting them to each other and to a central water feed device, whereby the actuation of the water output devices and of the central water feed device is carried out by a fire reporting device, characterized by the fact that the frame structure is laid out in accordance with static requirements conditioned on the basis of its structural function, i.e. without the known constructive means ensuring an adequate fire resistance period and that it attains its fire resistance by the use of spray nozzles (6) as water output devices and that these are arranged and disposed along at least a portion of the frame structure such that
the water is emitted from them as finely distributed spray droplets or aerosol, hereafter called mist,
that the marginal area of the output cones (7) of adjacent spray nozzles nozzles (6) overlap and in case of fire
the output cones (7) of all spray nozzles (6) initiated by the fire report envelope the parts of the frame structure in mist which lie within their reach.

2. The fire resistant frame structure of claim 1, characterized by the fact that the spray nozzles (6) are arranged at one side only of a frame structure and that their emission cones (7) extend to the next frame structure component.

3. The fire resistant frame structure of claim 1, characterized by the fact that the spray nozzles (6) are disposed at both sides of a frame structure component and that their output cones (7) extend up to the next structural component.

4. The fire resistant frame structure of claim 1-3, characterized by the fact that the spray jets (6) are arranged at the lower surface of a frame structure component.

5. The fire resistant frame structure of claim 1-4, characterized by the fact that the support components are also the water-conducting feed conduits.
